(19) United States
(12) Patent Application Publication
(10) Pub. No.: US 2006/0149406 A1
(43) Pub. Date: Jul. 6, 2006

(54) Production procedure planning system and method

(75) Inventors: Cheng-Ju Chen, Taipei (TW); Po-Wen Lu, Taipei (TW); Jih-Hong Huang, Taipei (TW); Shiou-Yu Hung, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/096,295

(22) Filed: Mar. 31, 2005

(30) Foreign Application Priority Data
Dec. 31, 2004 (TW) 093141710

(51) Int. Cl. G06F 19/00

(52) U.S. Cl. 700/107; 700/100

(57) ABSTRACT

A production procedure planning system and a production procedure planning method are applicable in a data processing device connected to a resource management system. A production schedule for a product to be manufactured is arranged by a scheduling mechanism, and content of a production procedure to be planned is computed by a factory planning mechanism compute according to the production schedule, so as to plan and send the production procedure to the resource management system. The resource management system generates a production procedure required for a production line according to the planned production procedure and sends the generated production procedure to the production line such that the production line can perform production according to the production procedure. By the above production procedure planning system and method, the production schedule can be applied to the product line without requiring complicated processes for planning production procedures, thereby effectively reducing the production cost.

### FIELD OF THE INVENTION

The present invention relates to production procedure planning systems and methods, and more particularly, to a production procedure planning system and method applicable in a data processing device connected to a resource management system.

### BACKGROUND OF THE INVENTION

The manufacturing industry purchases raw materials from suppliers and manufactures products through a processing or assembly procedure so as to sell the products to customers. This forms a characteristic feature of the manufacturing industry distinguishable from finance, commerce, mining (oils and minerals) and service industries. All operation and production activities of the manufacturing industry are associated with the products thereof, so is an information system for the manufacturing industry. A material management procedure starts from product structure or a bill of material (BOM) to realize a pyramid configuration of integrated material information, wherein the top layer of the pyramid configuration refers to outputted products managed under a marketing department of a business, the bottom layer of the pyramid configuration refers to purchased raw materials or accessories managed under a material supplying department of the business, and a middle layer refers to manufactured products managed under a production department.

According to priorities of demands, to integrate information about supply, production and sale for a business must be associated with a basic document BOM i.e. product structure. The BOM records a detailed list of quantities of components/parts required for producing particular products and also provides information about architecture of the products. Information of components for each product (including material numbers, product name, required specifications, quantities, etc.) is also contained in the BOM. Thus, the BOM is considered as a major document for product manufacture. The BOM illustrates priority and quantity relationships between different materials, and such relationships reflect production procedures and time periods. In other words, a forecast production quantity standard usually used in production management in the manufacturing industry can be clarified from the product structure. The BOM is primarily employed in the manufacturing industry for producing assembly products. If production procedures relating to working procedure, equipment or devices are integrated with the product structure, the features of procedural industries can be incorporated.

Accordingly, BOM plays an important role in production procedures for products, and serves as a Working basis for developers or producers, especially for the production department. For example, at a stage of arranging production procedures, conventional production procedure planning method and system operate via specific workers to compute all data within a production schedule, manually open up the BOM for the finished products, and compute information disclosed in the BOM stage by stage to plan production procedures stage by stage, such that production can be performed by the production line according to the production procedures. However, current products, especially electronic or other sophisticated mechanical products, are usually assembled by hundreds, thousands or even more than ten thousands of components/parts. In other words, if using the conventional production procedure planning technique, i.e. a manual method, as the BOM contains many primary stages and corresponding sub stages, to open the BOM up stage by stage is very time consuming. Usually a manufacturer of a relatively large scale may need to plan production procedures for hundreds of models of products per day such that much more human resource and time are required for planning the production procedures for such manufacturer if using the conventional manual method. This situation easily causes human mistakes in planning the production procedures or invalid production procedures as not able to instantly realize the updated stock data (because of failure in connection with a rear resource management system). Thus, not only a lot of time and human resources are wasted but also the accuracy and effectiveness of the planned production procedures cannot be assured.

Therefore, the problem to be solved here is to provide a production procedure planning system and method, which can directly plan a production procedure according to content of a production schedule.

### SUMMARY OF THE INVENTION

In light of the above drawbacks in the prior art, a primary objective of the present invention is to provide a production procedure planning system and method, which can directly plan a production procedure according to content of a production schedule.

Another objective of the present invention is to provide a production procedure planning system and method, which can send a planned production procedure directly to a rear resource management system.

Still another objective of the present invention is to provide a production procedure planning system and method so as to decrease mistakes that may be caused by a manual production procedure planning technique.

A further objective of the present invention is to provide a production procedure planning system and method so as to decrease invalid production procedures that may be caused by a manual production procedure planning technique due to failure in realizing stock data of a resource management system.

In order to achieve the above and other objectives, the present invention proposes a production procedure planning system that is applicable in a data processing device connected to a resource management system. The production procedure planning system comprises: a scheduling module for arranging a production schedule including production content, production time, production quantity and producer for a product to be manufactured; a factory planning module for computing a bill of material (BOM) required for planning a production procedure according to the production schedule; and a production procedure planning module for planning the production procedure according to the BOM.

The present invention also proposes a production procedure planning method performed through the production procedure planning system. The production procedure planning method comprises the steps of: firstly, arranging a production schedule including production content production time, production quantity and producer for a product to be manufactured; next, computing a BOM required for planning a production procedure according to the production schedule; then, planning the production procedure according to the BOM; sending the planned production procedure to the resource management system such that the resource management system generates a production procedure required for a production line according to the planned production procedure; and finally sending the generated production procedure required for the production line to the production line such that the production line can perform production according to the generated production procedure.

In comparison to the conventional production procedure planning technique, the production procedure planning system and method in the present invention utilize a scheduling mechanism to arrange a production schedule for a product to be manufactured, and allow a factory planning mechanism to compute content of a production procedure to be planned according to the production schedule so as to plan and send the production procedure to the resource management system. The resource management system generates a production procedure required for the production line according to the planned production procedure, and sends the generated production procedure to the production line such that the production line can perform production according to the generated production procedure. As a result, the production procedure can be directly planned from content of the production schedule. Thus, the present invention reduces mistakes that may be caused by a manual production procedure planning technique, and decreases invalid production procedures that may be caused by the manual production procedure planning technique due to failure in realizing stock data of the resource management system, such that the production cost can be effectively diminished.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram showing application architecture of a production procedure planning system according to the present invention; and

FIG. 2 is a flowchart showing steps of a production procedure planning method according to the present invention.

### DETAILED DESCRIPTION OF THE PREFFERED EMBODIMENTS

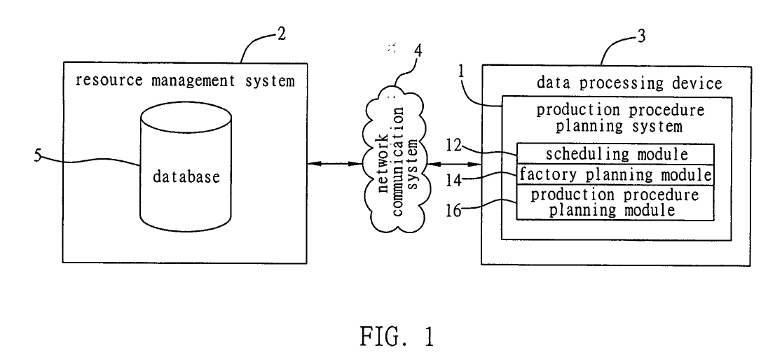

FIG. 1 shows application architecture of a production procedure planning system proposed in the present invention. As shown in FIG. 1, the production procedure planning system 1 is applicable in a data processing device 3 connected to a resource management system 2. In this embodiment, the resource management system 2 and the data processing device 3 are connected to each other via a network communication system 4. The network communication system 4 can be Internet, an intranet, or an extranet, etc. The data processing device 3 can be a personal computer (PC), notebook (NB), or workstation, etc. The resource management system 2 can be for example an enterprise resource planning (ERP) system, etc.

The production procedure planning system 1 in the present invention includes: a scheduling module 12, a factory planning module 14, and a production procedure planning module 16.

The scheduling module 12 is used to arrange a production schedule including production content, production time, production quantity and producer for a product to be manufactured. In this embodiment, the production procedure planning system 1 in the present invention can be applied to manufacturing processes of a notebook computer, such that the scheduling module 12 is used to arrange a production schedule including production content, production time, production quantity and producer for the notebook computer.

The factory planning module 14 is used to compute a bill of material (BOM) required for planning a production procedure according to the production schedule. In this embodiment, the factory planning module 14 depends on content of the production schedule including production content, production time, production quantity and producer for the notebook computer arranged by the scheduling module 12 so as to compute content of a BOM stage by stage from BOM data stored in a database 5 of the resource management system 2 corresponding to the content of production schedule such as production content, production time, production quantity and producer for the notebook computer. The BOM includes data fields such as name, serial number, specification, quantity and so on for each component/part required for product manufacture. Also, the BOM includes primary stage materials and sub stage materials. For example, the primary stage material may refer to a storage unit, and the sub stage materials may refer to devices containing detailed content corresponding to the storage unit such as hard disk drives of various specifications. Accordingly, the factory planning module 14 computes the BOM required for planning a production procedure according to the production schedule arranged by the scheduling module 12, wherein the BOM may include for example data such as required models or specifications of components/parts and so on for the product to be manufactured.

The production procedure planning module 16 is used to plan the production procedure according to the BOM computed by the factory planning module 14. As described above, in this embodiment, when the factory planning module 14 computes the BOM required for planning a production procedure according to the production schedule arranged by the scheduling module 12, the production procedure planning module 16 plans the production procedure according the BOM. Moreover, the production procedure planning module 16 can send the planned production procedure to the resource management system 2 such that the resource management system 2 can generate a production procedure required for a production line and the production line can perform production according to the generated production procedure.

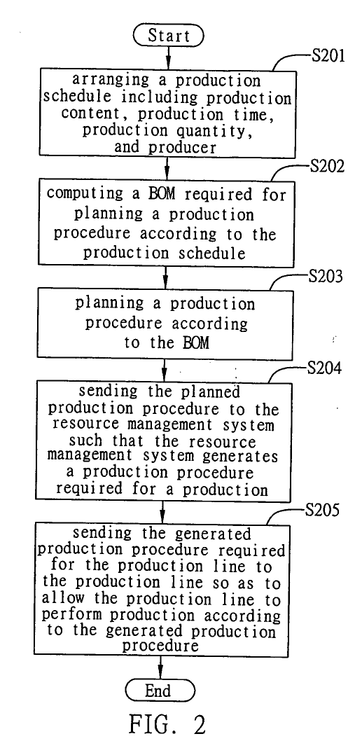

FIG. 2 shows steps of a production procedure planning method proposed in the present invention.

As shown in FIG. 2, in step S201, a production procedure for a product to be manufactured is arranged including production related data such as production content, time, quantity, producer, and so on. Then, the method proceeds to step S202.

In step S202, according to content of the production schedule, a BOM required for planning a production procedure is computed from BOM data stored in a database of a resource management system. The BOM includes data such as name, serial number, specification, quantity and so on for each component/part required for product manufacture. Then, the method proceeds to step S203.

In step S203, the production procedure is planned according to the data such as name, serial number, specification, quantity and so on for each component/part from the BOM computed in step S202. Then, the method proceeds to step S204.

In step S204, the planned production procedure is sent to the resource management system such that the resource management system generates a production procedure required for a production line according to the planned production procedure. Then, the method proceeds to step S205.

In step S205, the generated production procedure required for the production line is sent to the production line such that the production line can perform production according to the generated production procedure.

Therefore, the production procedure planning system and method in the present invention utilize a scheduling mechanism to arrange a production schedule for a product to be manufactured, and allow a factory planning mechanism to compute content of a production procedure to be planned according to the production schedule so as to plan and send the production procedure to the resource management system. The resource management system generates a production procedure required for the production line according to the planned production procedure, and sends the generated production procedure to the production line such that the production line can perform production according to the generated production procedure. As a result, the production procedure can be directly planned from content of the production schedule. Thus, the present invention reduces mistakes that may be caused by a manual production procedure planning technique, and decreases invalid production procedures that may be caused by the manual production procedure planning technique due to failure in realizing stock data of the resource management system, such that the production cost can be effectively diminished.

The invention has been described using exemplary preferred embodiments. However, it is to be understood that the scope of the invention is not limited to the disclosed embodiments. On the contrary, it is intended to cover various modifications and similar arrangement. The scope of the claims therefore should be accorded the broadest interpretation so as to encompass all such modifications and similar arrangements.

What is claimed is:

1. A production procedure planning system applicable in a data processing device connected to a resource management system, the production procedure planning system comprising:
a scheduling module for arranging a production schedule including production content, production time, production quantity and producer for a product to be manufactured;
a factory planning module for computing a bill of material required for planning a production procedure according to the production schedule; and
a production procedure planning module for planning the production procedure according to the bill of material.

2. The production procedure planning system of claim 1, wherein the resource management system and the data processing device are connected to each other via a network communication system.

3. The production procedure planning system of claim 2, wherein the network communication system is Internet, an intranet, or an extranet.

4. The production procedure planning system of claim 1, wherein the bill of material includes data of model numbers and specifications of components/parts for the product to be manufactured.

5. The production procedure planning system of claim 1, wherein the production procedure planning module is further for sending the planned production procedure to the resource management system for generating a production procedure required for a production line, so as to allow the production line to perform production according to the generated production procedure.

6. The production procedure planning system of claim 1, wherein the data processing device is a personal computer, notebook computer, or workstation.

7. The production procedure planning system of claim 1, wherein the resource management system is an enterprise resource planning system.

8. A production procedure planning method applicable in a data processing device connected to a resource management system, the production procedure planning method comprising the steps of:
arranging a production schedule including production content, production time, production quantity and producer for a product to be manufactured;
computing a bill of material required for planning a production procedure according to the production schedule;
planning the production procedure according to the bill of material;
sending the planned production procedure to the resource management system such that the resource management system generates a production procedure required for a production line according to the planned production procedure; and
sending the generated production procedure required for the production line to the production line so as to allow the production line to perform production according to the generated production procedure.

9. The production procedure planning method of claim 8, wherein the bill of material includes data of model numbers and specifications of components/parts for the product to be manufactured.

10. The production procedure planning method of claim 8, wherein the resource management system and the data processing device are connected to each other via a network communication system.

11. The production procedure planning method of claim 10, wherein the network communication system is Internet, an intranet, or an extranet.

12. The production procedure planning method of claim 8, wherein the data processing device is a personal computer, notebook computer, or workstation.

13. The production procedure planning method of claim 8, wherein the resource management system is an enterprise resource planning system.
